(19) United States
(12) Patent Application Publication
(10) Pub. No.: US 2013/0206274 A1
(43) Pub. Date: Aug. 15, 2013

(54) PROCESS FOR PRODUCING LARGE DIAMETER, HIGH STRENGTH, CORROSION-RESISTANT WELDED PIPE AND PIPE MADE THEREBY

(71) Applicants: Gaylord D. Smith, Huntington, WV (US); Ronald D. Gollihue, Grayson, KY (US); Brian A. Baker, Kitts Hill, OH (US); Lewis E. Shoemaker, Barboursville, WV (US)

(72) Inventors: Gaylord D. Smith, Huntington, WV (US); Ronald D. Gollihue, Grayson, KY (US); Brian A. Baker, Kitts Hill, OH (US); Lewis E. Shoemaker, Barboursville, WV (US)

(73) Assignee: HUNTINGTON ALLOYS CORPORATION, Huntington, WV (US)

(21) Appl. No.: 13/814,309

(22) PCT Filed: Jul. 19, 2011
(86) PCT No.: PCT/US11/44455

§ 371 Date: Apr. 5, 2013

Related U.S. Application Data
(60) Provisional application No. 61/374,771, filed on Aug. 18, 2010.

(51) Int. Cl. F16L 9/17; F16L 9/02; B23K 9/16; B23K 9/02; B21D 39/02; B21B 21/00

(52) U.S. Cl. CPC F16L 9/17; B21D 39/028; B21B 21/00; B23K 9/164; B23K 9/0213; F16L 9/02
USPC 138/177; 72/368; 72/370.14; 219/74; 148/521

(57) ABSTRACT

A method of roll-forming sheet or plate into a round hollow, welding the round hollow with a welding alloy that matches the alloy of the round hollow to form a welded pipe, annealing the welded pipe at a minimum of 1950° F. to provide a carbide-free microstructure, ultrasonic inspecting to assure sound welds, and cold-working the annealed and inspected pipe via drawing or pilgering to the desired tensile strength. The compositional range alloys suitable for use in the method of the present invention in weight % is: 25.0-65.0% Ni, 15.0-30.0% Cr, 0-18.0% Mo, 2.5-48.0% Fe, 0-5.0% Cu, 0-5.0% Mn, 0-5.0% Nb, 0-2.0 Ti, 0-5.0% W, 0-1.0% Si, and 0.005-0.1% C. The process has been most preferably optimized for an alloy range consisting of 32.0-46% Ni, 19.5-28.0% Cr, 18.0-40.0% Fe, 3.0-8.0% Mo, 1.0-3.0% Cu, 0.6-1.2% Ti, 0.5-2.0% Mn, 0.1-0.5% Si, 0.01-0.08% C. The present invention also includes the pipe made thereby.

### BACKGROUND OF THE INVENTION

1. Field of the Invention

The present invention is directed to a method for producing welded pipe and the pipe made thereby in the outside diameter size range of 5½″ or larger of an alloy range capable of being cold-worked to high strength, ideally a minimum of 110 ksi yield strength as cold-worked by pilgering or by drawing, with adequate corrosion resistance for service in sour gas and oil wells and transport piping as defined by no corrosive attack in the ASTM G-48C environment.

2. Description of Related Art

Large diameter pipe in the outside diameter (OD) size range 5½″ to 9⅝″ or more is becoming increasingly in demand for sour gas and oil drill pipe, casings and transport pipe. Such large diameter pipe will also find application in other applications, such as are found in the chemical, petrochemical, pulp and paper, marine engineering, pollution control and power industries. This pipe must have high strength and adequate corrosion resistance for the service. These service requirements can potentially be met by a family of cold-worked solution nickel-containing alloys, such as alloys 25-6MO, 25-6HN, 27-7MO, 800, 020, 028, G-3, 825, 050, 625 and C-276 as defined in Table 1 processed using the processing steps defined herein.

TABLE 1
Nominal Composition of the Candidate Alloys for Use with the Invention

| Alloy | UNS | Ni | Cr | Mo | Fe | Cu | Other |
|---|---|---|---|---|---|---|---|
| 25-6HN | N08367 | 25.0 | 21.0 | 6.7 | 45.0 | 0.020 | 0.30Mn |
| 25-6MO | N08926 | 25.0 | 21.0 | 6.7 | 45.0 | 0.85 | 0.67Mn |
| 27-7MO | UNS- | 27.0 | 22.0 | 7.3 | 40.3 | 0.75 | 1.3Mn |
| | S31277 | | | | | | |
| 800 | N08800 | 32.0 | 20.0 | — | 46.0 | — | 0.8Mn |
| 020 | N08020 | 35.0 | 20.0 | 2.5 | 37.0 | 3.5 | 0.6Nb |
| 028 | N08028 | 32.0 | 27.0 | 3.5 | 36.5 | 1.0 | 2.0Mn |
| 825 | N08825 | 43.0 | 23.0 | 3.0 | 28.0 | 2.0 | 1.0Ti |
| G-3 | N06985 | 44.0 | 22.0 | 7.0 | 19.5 | — | — |
| 050 | N06950 | 50.0 | 20.0 | 9.0 | 17.0 | — | — |
| 625 | N06625 | 60.9 | 21.6 | 9.1 | 4.0 | — | 3.5Nb |
| C-276 | N10276 | 57.0 | 16.0 | 16.0 | 5.5 | — | 4.0W |

Alloy 27-7MO performs well in mixed acid environments, especially those containing oxidizing and reducing acids and offers excellent resistance to pitting and crevice corrosion as is present in marine, sour gas and deepwater oil wells. Alloy 028 is a corrosion resistant austenitic stainless steel tailored for downhole application in oil and gas operations. Alloy 020 is a stabilized version of the alloy with good pitting resistance in environments containing chlorides and sulfides. Alloy 825 is a Ti stabilized alloy with excellent resistance to both reducing and oxidizing acids as well as stress-corrosion and intergranular corrosion environments. Alloy 825 is widely used in sour gas and oil drilling and well extraction. Alloy 050 possesses excellent resistance to stress-corrosion cracking, particularly in sour gas and oil environments. Alloys 625 and C-276 offer the ultimate in resistance to reducing and mildly oxidizing environments and are widely used in chemical and petrochemical service as well as in sour gas and oil production. Alloy 625 is especially resistant to pitting and crevice corrosion resistance. Matching composition filler metal weld products exist for alloy 825 (A5 14 ERNiFeCr-1), alloy G-3 (A5 14 ERNiCrFeMo-9), alloy 625 (A5.14ERNiCrMo-3) and for alloy C-276 (A5 14 ERNiCrMo-4). These welding products are of identical composition to the matching base-metal alloy.

Nickel is a primary alloying element in providing a matrix that is cold-workable while retaining ductility, toughness and providing stability to the alloy. Nickel improves weldability, resistance to reducing acids and caustics, and enhances resistance to stress-corrosion cracking, particularly in chloride environments typical to that of sour gas and oil wells.

Chromium improves resistance to oxidizing corrosives and sulfidation and enhances resistance to pitting and crevice corrosion.

Molybdenum and tungsten improve resistance to reducing acid conditions and to pitting and crevice corrosion in aqueous chloride containing environments.

Titanium and niobium combine with carbon to reduce susceptibility to intergranular corrosion due to chromium carbide precipitation resulting from heat treatments.

One known method of producing the required pipe consists of forming a solid billet by casting and forging to a size suitable for extrusion. The billet is either pierced to create a hole suitable for the mandrel used to form the inside diameter of the extrudate or by trepanning an equivalent hole prior to extrusion. The extrusion process produces a shell suitable to be subsequently cold-worked to finished size. The process is handicapped by the inability of most extrusion presses to extrude a shell that is of sufficient size to form a finished pipe of adequate length for commercial use. Also inherent in an extrusion pipe are questions regarding ovality and dimensional control along the length of the extrudate. An additional drawback is the significant expense of extrusion and the limited availability of commercial extrusion presses available to produce shells of any size approaching what is required for oil country service. Pipe made via extrusion does have the benefit of being microstructurally homogeneous around the circumference, thus eliminating any concern for potential defects resulting from a longitudinal seam welded joint.

Alternatively, a pipe can be made by roll-forming plate or sheet into a round and subsequently welding the round. Such a process is disclosed in U.S. Pat. No. 6,880,220. However, the process so described does not meet the harsh environmental conditions in oil country pipe service as defined by ASTM G-48C when annealed at 1775° F./1 hr as prescribed by the full anneal defined in U.S. Pat. No. 6,880,220. Further this patent requires that the weld bead be planished (rolled, flattened or forged) along its entire longitudinal length prior to the full anneal in order to recrystallize the grain structure of the weld. However, this procedure is difficult to accomplish in practice and is expensive and time consuming. Since planishing does not cold-work the entire weld throughout, the resultant microstructure is not homogeneous.

U.S. Pat. No. 6,532,995 discloses a method for welding alloy steel pipe for high strength service with the intention of transporting natural gas and crude oil. Unfortunately, the alloys of the '995 patent do not possess the strength for current deepwater sour gas and oil drilling, the necessary corrosion resistance, or a cold-worked and annealed weld to eliminate the cast microstructure of the weld.

U.S. Pat. No. 6,375,059 discloses a method and an apparatus for smoothing a welded longitudinal seam weld such as the one produced by the process of the aforementioned '995 patent.

The present invention provides processing steps that eliminate the need to planish the weld and still achieve a uniform, homogeneous microstructure, mechanical properties and corrosion resistance essentially equivalent to that of the base metal.

The present invention is directed to an improved process meeting the requirements for current sour gas and oil production equipment while achieving the microstructure and mechanical properties of seamless pipe, albeit at a much reduced cost.

### SUMMARY OF THE INVENTION

The method of the present invention consists of roll-forming sheet or plate into a round hollow, welding the round hollow with a welding alloy that matches the alloy of the round hollow to form a welded pipe, annealing the welded pipe to provide a carbide-free microstructure, ultrasonic inspecting to assure sound welds, and then cold-working the annealed and inspected pipe via drawing or pilgering to a desired tensile strength. The pipe is adequately cold-worked within limits to achieve the required strength but not so much as to limit ductility and toughness. Further, the annealing step is optimized to assure full solution of the chromium carbides and to homogenize the grain boundary area in order to retard their re-precipitation upon subsequent cold-work and consequently eliminate sensitization of the weld and base metal. For the alloy 825 example below, annealing may be at a minimum of 1950° F. for one hour. Such an anneal prior to cold-working is essential to achieve ASTM G-48C corrosion resistance and to augment the cold-working strength response. An anneal plus cold-work within controlled limits (45% to 65% reduction) is sufficient to eliminate the as-cast weld structure resulting in a pipe that is essentially equivalent in microstructure and properties to that of a non-welded pipe made via the extrusion process. The compositional range of alloys suitable for use in the method of the present invention in weight % is: 25.0-65.0% Ni, 15.0-30.0% Cr, 0-18.0% Mo, 2.5-48.0% Fe, 0-5.0% Cu, 0-5.0% Mn, 0-5.0% Nb, 0-2.0 Ti, 0-5.0% W, 0-1.0% Si, and 0.005-0.1% C. The compositional range of alloys preferred for use in the method of the present invention in weight % is 32.0-46.0% Ni, 19.5-28.0% Cr, 18.0-40.0% Fe, 3.0-8.0% Mo, 1.0-3.0% Cu, 0.6-1.2% Ti, 0.5-2.0% Mn, 0.1-0.5% Si, 0.01-0.08% C. The present invention also includes the pipe made thereby, particularly large diameter pipe having an outside diameter (OD) size range of about 5½″ to 9⅝″, and greater.

### BRIEF DESCRIPTION OF THE DRAWINGS

FIG. 1 is a photomicrograph showing a cross-section of the weld area of the as-welded pipe of the present invention prior to annealing and pilgering; and

FIG. 2 is a photomicrograph showing a cross-section of the homogeneous microstructure of the weld area following full processing according to the present invention.

### DETAILED DESCRIPTION OF THE INVENTION

Alloy 825 was selected for the development of the present process. The composition of the two heats of alloy 825 that were selected were: 1) Heat HH1407F: 42.3% Ni, 28.6 Fe, 22.8% Cr, 3.0% Mo, 0.1% Nb, 0.44% Ti, 2.1% Cu, 0.6% Mn, 0.1% Si, and 0.007% C and 2) Heat HH1541F: 41.1% Ni, 29.0 Fe, 23.2% Cr, 3.3% Mo, 0.2% Nb, 1.02% Ti, 1.7% Cu, 0.3% Mn, 0.22% Si and 0.009% C. Two annealing conditions were ultimately used for the study (1750° F./1 hr/WQ and 1950° F./1 hr/WQ) and ASTM Corrosion Test Standard G-48C was selected to define the corrosion resistance of the finished pipe including the weld joint. Standard ASTM mechanical test procedures were used to define the tensile properties and hardness. Ultrasonic testing was used to confirm the soundness of the seam weld. Matching filler metal was employed as the welding product and both Gas Metal Arc (GMA) Welds and Gas Tungsten Arc (GTA) Welds were evaluated. However, other welding techniques, such as, Submerged Arc Welding (SAW), Plasma Arc Welding (PAW) and Friction-Stirred welding may also be employed.

Cold-rolled plate (0.708 inch thick) of the alloy 825 compositions described above were annealed at 1750° F./1 hr/WQ, formed into pipe, welded, annealed after welding, and cold rolled at 40%, 45%, and 55% reductions in order to replicate the minimum required pilgering cold reductions and to establish the response of the tensile properties and corrosion resistance of the alloy to the effect of cold-work. The post weld annealing for Heat HH1541F was at 1750° F./1 hr/WQ and for Heat HH1407F was at 1950° F./1 hr/WQ. Table 2 presents tensile properties and hardness as a function of percent cold-work. It should be pointed out that as-cold rolled plate tensile properties do not correlate exactly with as-pilgered tube tensile properties due to the nature of the deformation process and its effect on microstructure. Given an equivalent reduction by cold-work, cold-rolled or drawn plate tensile properties can be as much as 30% greater (compare the reduction of 45% cold-worked plate with the 9⅝″ OD pilgered pipe given the equivalent reduction as disclosed hereinafter).

TABLE 2
Tensile Properties and Hardness of Cold Rolled Alloy 825 Plate
Post-Welding Annealed At 1750° F./1 hr/WQ or
1950° F./1 hr/WQ and Subsequently Cold-Rolled

| % Cold Rolled | 0.2% Y.S. - ksi | U.T.S. - ksi | % Elong. | Rc Hardness |
|---|---|---|---|---|
| 40%* | 125.3 | 141.7 | 12.4 | — |
| 45%* | 121.8 | 135.5 | 12.2 | 27 |
| 55%* | 126.6 | 136.9 | 6.0 | 26 |
| 40%** | 127.9 | 143.6 | 12.1 | 32 |
| 45%** | 144.1 | 160.0 | 12.8 | 31 |

*Heat HH1541F: Anneal at 1750° F./1 hr/WQ + welded + 1750° F./1 hr/WQ + cold rolled as shown.
**Heat HH1407F: Anneal at 1750° F./1 hr/WQ + welded + 1950° F./1 hr/WQ + cold rolled as shown

To simulate the field conditions of the typical sour gas and oil environment, the ASTM G-48C pitting test was selected to validate performance. The alloy 825 was evaluated by testing according to the conditions of ASTM G-48C at the stated temperatures for a period of 72 hours (duplicate samples). The results are presented in Table 3 for the 1750° F. anneal and in Table 4 for the 1950° F. anneal.

TABLE 3
ASTM G-48C Testing of Alloy 825 Plate as a Function of Cold-Work
and Post-Welding Annealing Conditions of 1750° F./1 hr-3 hr/WQ
G-48C Test Conditions: 6% FeCl₃ + 1% HCl + Bal.
Purified Water for 72 hours

| | Test Temperature, | Pit Max. Depth | Corrosion Rate Mils |
|---|---|---|---|
| Condition | ° F. | Bold Face, mils | per Year |
| 1 | 68 | 6 in Weld | Excessive |
| 2 | 68 | 70 in HAZ | Excessive |
| | | 8 in Base Metal | |
| 3 | 68 | 80 in HAZ | Excessive |
| | | 30 in Base Metal | |
| 4 | 68 | 25 in HAZ | Excessive |

Condition 1—Annealed at 1750° F./1 hr/WQ + welded + 1750° F./1 hr/WQ + cold rolled 45%
Condition 2—Annealed at 1750° F./1 hr/WQ + welded + 1750° F./2 hr/\WQ + cold rolled 45%
Condition 3—Annealed at 1750° F./1 hr/WQ + welded + 1750° F./3 hr/WQ + cold rolled 55%
Condition 4—Condition 2 sample reannealed after cold-working at 1850° F./1 hr/WQ

TABLE 4
ASTM G-48C Testing of Welded Alloy 825 Plate and Pipe Annealed
at 1950° F./1 hr/WQ and Cold-Worked by Rolling and Pilgering

| | Test Temperature, | Pit Max. Depth | Corrosion Rate |
|---|---|---|---|
| Condition | ° F. | Bold Face, mils | Mils per Year |
| 1 | 68 | None | No Attack |
| 1 | 77 | None | 1 |
| 2 | 68 | None | No Attack |
| 3 | 68 | None | No Attack |
| 4 | 68 | None | No Attack |

Condition 1—Annealed at 1750° F./1 hr/WQ + welded + 1950° F./1 hr/WQ + cold rolled 35% as plate
Condition 2—Annealed at 1750° F./1 hr/WQ + roll-formed and welded + 1950° F./1 hr/WQ + pilgered 45% as pipe
Condition 3—Annealed at 1750° F./1 hr/WQ + roll-formed and welded + 1950° F./1 hr/WQ + pilgered 62% as pipe
Condition 4—Annealed at 1750° F./1 hr/WQ + roll-formed and welded + 1950° F./1 hr/WQ + pilgered 45% + 1950° F./1 hr/WQ + cold rolled 40% as plate section from pipe

On the basis of these corrosion results, it is evident that the annealing conditions disclosed in U.S. Pat. No. 6,880,220 (1775° F./1 hr/WQ) are inadequate to meet the corrosion resistance requirements of deepwater sour oil and gas drilling wells and transport piping if the alloy is cold-worked such that the alloy meets strength targets. Condition 4 in Table 3 suggests that the lack of adequate corrosion resistance is due to an induced microstructural characteristic from the process of the '220 patent that is not corrected even by an anneal at 1750° F./3 hr/WO or even 1850° F./1 hr/WQ after cold-working. A new set of processing conditions were developed and evaluated in order to achieve both corrosion resistance and strength.

The Gas Metal Arc (GMA) welding conditions for the above materials is presented in Table 5.

TABLE 5
Alloy 825 GMA Welding Parameters Utilizing Matching Filler Metal

| Parameter | Value |
|---|---|
| Base Material | Heat HH1541F (0.708″ Gauge) and |
| | HH1407F (0.75″ Gauge) |
| Filler Metal | Heat HH6158F (0.045″ Dia. Wire) and |
| | HV1075 (0.045″ Dia. Wire |
| Weld Restraint | Fully Restrained |
| Average Amperage | 200 |
| Average Voltage | 30 |
| Wire Speed | 280 Inches/Minute |
| Shielding Gas | 75% Argon/25% Helium @ 35 cfh |

Root Pass GTA utilizing 175 amps. At 14.6 volts
Composition of Heats
HH1541F—41.1% Ni, 29.0% Fe. 23.2% Cr, 3.3% Mo, 0.2% Nb, 1.02% Ti, 1.7% Cu, 0.3% Mn, 0.22% Si, 0.009% C
HH1407F—42.3% Ni, 28.6% Fe, 22.8% Cr, 3.0% Mo, 0.1% Nb, 0.44% Ti, 2.1% Cu, 0.6% Mn, 0.1% Si, and 0.007% C
HH6158F—44.2% Ni, 28.3% Fe, 22.1% Cr, 2.7% Mo, 0.03% Nb, 0.65% Ti, 1.8% Cu, 0.4% Mn, 0.14% Si, 0.017% C
HV1075—43.0% Ni, 28.2% Fe, 21.9% Cr, 3.1% Mo, 0.5% Nb, 1.00% Ti, 1.6% Cu, 0.5% Mn, 0.17% Si, 0.018% C

Plate (0.75 inch thick) of the alloy 825 composition (Heat HH1407F) was annealed after welding at 1950° F./1 hr/WQ and subsequently cold rolled nominally at 40% and 45% reductions in order to establish the alloy's tensile properties and corrosion resistance response to the effect of cold-work. Table 6 presents the tensile properties and hardness as a function of percent cold-work of the base metal plate, and Table 7 presents the transverse weld tensile properties of matching composition GMA welds made using 0.045″ weld wire from Heat HV1075 (43.0% Ni, 28.2% Fe, 21.9% Cr, 3.1% Mo, 0.5% Nb, 1.00% Ti, 1.6% Cu, 0.5% Mn, 0.17% Si, 0.018% C).

TABLE 6
Tensile Properties and Hardness of Cold Rolled Alloy 825
Annealed at 1950° F./1 hr/WQ and Subsequently Cold Rolled

| % Cold Rolled | 0.2% Y.S. - ksi | U.T.S. - ksi | % Elong. | Rc Hardness |
|---|---|---|---|---|
| 30% | 113.8 | 125.2 | 16.0 | 24 |
| 35% | 118.0 | 131.1 | 15.1 | 27 |
| 40% | 127.9 | 143.6 | 12.1 | 32 |
| 45% | 144.1* | 160.0 | 12.8 | 31 |

*0.5% Y.S.

TABLE 7
Tensile Properties and Hardness of Transverse Matching
Composition GMA Welds of Alloy 825 Annealed at
1950° F./1 hr/WQ and Subsequently Cold Rolled

| % Cold Rolled | 0.2% Y.S. - ksi | U.T.S. - ksi | % Elong. | Rc Hardness |
|---|---|---|---|---|
| 40% | 124.4 | 133.4 | 8.5 | 32 |
| 44% | 128.8 | 138.6 | 12.6 | 31 |

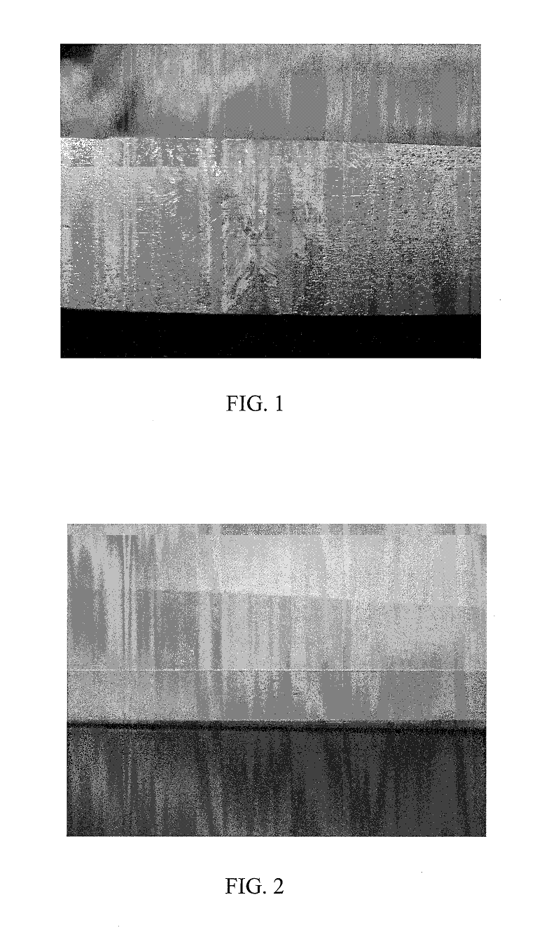

Fabrication of Pipe Utilizing the Process Steps Developed Using Plate: To determine the effect of pilgering on tensile properties of both the weld metal and the base metal, a pipe (3.25″ OD×0.463″ wall) was made from heat HH1718F (44.7% Ni, 25.7% Fe, 22.9% Cr, 3.3% Mo, 0.2% Nb, 0.77% Ti, 1.8% Cu, 0.5% Mn, 0.13% Si, 0.014% C) and annealed at 1750° F./1 hr/WQ after which a 60° included angle beveled longitudinal groove slit was made in the pipe and rejoined using matching filler metal from heat HV1075 (43.0% Ni, 28.2% Fe, 21.9% Cr, 3.1% Mo, 0.5% Nb, 1.00% Ti, 1.6% Cu, 0.5% Mn, 0.17% Si, 0.018% C) using the GMA welding parameters defined in Table 5 followed by post-weld annealing in a continuous annealing furnace at 1950° F./1 hr/WQ. The as-welded and annealed pipe was subsequently pilgered 61% to a 1.904″ OD×0.395″ wall. The base metal longitudinal tensile properties (average of duplicate samples) were 134.7 ksi 0.2% Y.S., 146.7 ksi U.T.S. and 18.7% elongation. The average base metal hardness was 32.1 Rc. The all-weld metal tensile properties (average of duplicate samples) were 126.0 ksi 0.2% Y.S., 137.4 ksi U.T.S. and 18.6% elongation. The average weld metal hardness was 30.4 Rc. The ASTM G-48C corrosion test results showed an attack of zero mils per year at 68° F. FIG. 1 is a depiction of the as-welded pipe prior to annealing and pilgering. FIG. 2 shows the homogeneous microstructure of the weld area following full processing including annealing and pilgering to finished pipe.

Fabrication of Large Diameter Pipe Utilizing the Improved Process Steps Developed Above: A 9⅝″ outer diameter pilgered pipe of alloy 825 was produced using material from heat HH1821F (41.64% Ni, 29.4% Fe, 22.50% Cr, 3.19% Mo, 0.22% Nb, 0.81% Ti, 1.74% Cu, 0.4% Mn, 0.13% Si, 0.01% C) that had been mill annealed and welded with matching filler metal using 0.045″ wire from heat HV1075 (43.0% Ni, 28.2% Fe, 21.9% Cr, 3.1% Mo, 0.5% Nb, 1.00% Ti, 1.6% Cu, 0.5% Mn, 0.17% Si, 0.018% C). The welding technique used was Gas Tungsten Arc (GTA) for which the nominal operating parameters were 200 amperes and 15 volts using a helium shielding gas and a travel speed of 5 inches/minute. The original plate thickness that was roll-formed to an 11″ OD diameter pipe was 1.027″. Following roll-forming and welding, the pipe was annealed at 1950° F./1 hr/WQ and subsequently pilgered at an approximate 45% reduction to 9⅝″ OD×0.561″ thickness. The base metal tensile properties at the 3 o'clock position were 110.2 ksi 0.2% Y.S., 114.8 ksi U.T.S. and 21.4% elongation. The hardness was 27 Rc. The all-weld metal tensile properties were 114.6 ksi 0.2% Y.S., 118.6 ksi U.T.S. and 19.3% elongation. The hardness was 27 Rc. The ASTM G-48C corrosion test results showed an attack of zero mils per year at 68° F. It will be noted that the ratio of the transverse 0.2% Y.S. of the weld metal to that of the base metal is 1.04 for GTA welded pipe in contrast to a ratio of 0.935 for the GMA welded pipe, suggesting a potential benefit of GTA welding to that of GMA.

Double Annealed and Double Cold-Worked Pipe Process Utilizing the Improved Process Steps Developed Above: Where maximum length is desired, a double anneal and double cold-worked pipe can achieve the same desired strength and corrosion resistance using the processing parameters described above provided that the necessary starting length and gauge are employed such that the desired final dimensions are achieved. Such a step has the additional advantage of lowering the cost of the welding step on a per foot basis. An example of a double anneal and double cold-working operation is presented. A section of pipe made from heat HH1821F (41.64% Ni, 29.4% Fe, 22.50% Cr, 3.19% Mo, 0.22% Nb, 0.81% Ti, 1.74% Cu, 0.4% Mn, 0.13% Si, 0.01% C) was selected to demonstrate the acceptability of a double anneal and double cold-work process. The pipe was welded with matching filler metal using 0.045″ wire from heat HV1075 (43.0% Ni, 28.2% Fe, 21.9% Cr, 3.1% Mo, 0.5% Nb, 1.00% Ti, 1.6% Cu, 0.5% Mn, 0.17% Si, 0.018% C). The welding technique used was Gas Tungsten Arc (GTA) for which the nominal operation parameters were 200 amperes and 15 volts using 75% argon/25% helium shielding gas and a travel speed of 5 inches per minute. Following the welding step, the pipe was annealed at 1950° F./1 hr/WQ and subsequently pilgered 45% from an 11.0″ OD×0.1027″ wall to a 9.625″ OD×0.561″ wall. The section of the pipe was then annealed at 1950° F./1 hr/WQ and cold-worked 40% to a section thickness of 0.333″. For the base metal, the average of two room temperature (RT) tensile tests was 123 ksi 0.2% Y.S., 135.2 ksi U.T. S., and 14.8% elongation. The hardness was Rc28. For the welded joint, the average of two RT tensile tests was 118.9 ksi 0.2% Y.S., 133.4 ksi U.T.S. and 7.4% elongation. The corrosion test specimens exhibited zero mils per year corrosion rates at 68° F. for both the base metal and the welded joint using the ASTM G-48C test conditions.

While specific embodiments of the invention have been described in detail, it will be appreciated by those skilled in the art that various modifications and alternatives to those details could be developed in light of the overall teachings of the disclosure. The presently preferred embodiments described herein are meant to be illustrative only and not limiting as to the scope of the invention which is to be given the full breadth of the appended claims and any and all equivalents thereof.

The invention claimed is:

1. A process for the manufacture of large diameter pipe having high strength and corrosion resistance, suitable for use in sour gas and oil wells as drill pipe, casings, and transport pipe for petroleum products, comprising the steps of:
(a) providing an alloy of a composition comprising in weight %: 25.0-65.0% Ni, 15.0-30.0% Cr, 0-18% Mo, 2.5-48.0% Fe, 0-5.0% Cu, 0-5.0% Mn, 0-5.0% Nb, 0-2.0 Ti, 0-5.0% W, 0-1.0% Si, and 0.005-0.1% C;
(b) forming the alloy of step (a) into annealed plate or sheet;
(c) roll-forming the plate or sheet of step (b) into an elongated, hollow round shape;
(d) welding the elongated round shape along a longitudinal seam to provide welded pipe shell;
(e) annealing the welded pipe shell at a time and temperature sufficient to provide a carbide-free microstructure; and
(f) cold-working the annealed pipe shell by elongating said shell to a desired tensile strength for a finished pipe of a desired outside diameter.

2. The process of claim 1, wherein the alloy provided in step (a) comprises: 32.0-46.0% Ni, 19.5-28.0% Cr, 18.0-40.0% Fe, 3.0-8.0% Mo, 1.0-3.0% Cu, 0.6-1.2% Ti, 0.5-2.0% Mn, 0.1-0.5% Si, 0.01-0.08% C.

3. The process of claim 1 or 2, wherein the outside diameter of the finished pipe is at least 5½″.

4. The process of claim 3, wherein the finished pipe has an outside diameter at least 9⅝″.

5. The process of claim 1 or 2, wherein the annealing step (e) is conducted at a minimum temperature of 1950° F. for at least one hour in order to provide a carbide-free microstructure.

6. The process of claim 1 or 2, wherein the cold-working step (f) is conducted by one of drawing or pilgering.

7. The process of claim 6, wherein the cold-working step (f) is conducted by pilgering at a cold reduction of 40% to 65%.

8. The process of claim 6, wherein the annealing step (e) is conducted at about 1950° F. followed by water quenching and the cold-working step (f) is conducted by pilgering at a cold reduction of about 45% to produce a pipe having an outside diameter of at least 9⅝″.

9. The process of claim 1 or 2, wherein the welding step (d) is conducted by one of gas metal arc or gas tungsten arc.

10. The process of claim 9, wherein the welding step (d) is conducted by gas metal arc.

11. The process of claim 9, wherein the welding step (d) is conducted by gas tungsten arc.

12. A large diameter pipe made according to the process according to claims 1 to 11.

13. A large diameter pipe in a roll-formed, welded, annealed and cold-worked condition having high strength of at least 110 ksi yield strength for service in sour gas and oil wells and transport piping for petroleum products and possessing corrosion resistance as defined in ASTM G-48C, said pipe made from an alloy comprising: 25.0-65.0% Ni, 15.0-30.0% Cr, 0-18.0% Mo, 2.5-48.0.% Fe, 0-5.0% Cu, 0-5.0% Mn, 0-5.0% Nb, 0-2.0 Ti, 0-5.0% W, 0-1.0% Si, and 0.005-0.1% C.

14. The pipe of claim 13, wherein the alloy comprises: 32.0-46.0% Ni, 19.5-28.0% Cr, 18.0-40.0% Fe, 3.0-8.0% Mo, 1.0-3.0% Cu, 0.6-1.2% Ti, 0.5-2.0% Mn, 0.1-0.5% Si, 0.01-0.08% C.

15. The process of claim 1, wherein the welding of step (d) uses a filler metal comprising in weight %: 25.0-65.0% Ni, 15.0-30.0% Cr, 0-18% Mo, 2.5-48.0% Fe, 0-5.0% Cu, 0-5.0% Mn, 0-5.0% Nb, 0-2.0 Ti, 0-5.0% W, 0-1.0% Si, and 0.005-0.1% C.

16. The process of claim 1, further comprising repeating steps (e) and (f) at least one more time.
